(19) United States
(12) Patent Application Publication
(10) Pub. No.: US 2022/0375186 A1
(43) Pub. Date: Nov. 24, 2022

(54) METHOD AND APPARATUS FOR GENERATING BOUNDING BOX, DEVICE AND STORAGE MEDIUM

(71) Applicant: BEIJING BAIDU NETCOM SCIENCE TECHNOLOGY CO., LTD., Beijing (CN)

(72) Inventors: Hao LI, Beijing (CN); Zhangwei MENG, Beijing (CN); Gen LI, Beijing (CN); Jian SUN, Beijing (CN); Lu ZHANG, Beijing (CN)

(73) Assignee: BEIJING BAIDU NETCOM SCIENCE TECHNOLOGY CO., LTD., Beijing (CN)

(21) Appl. No.: 17/818,051

(22) Filed: Aug. 8, 2022

(30) Foreign Application Priority Data
Mar. 4, 2022 (CN) 2022102126723

(51) Int. Cl. G06V 10/22; G06T 7/50; G06T 7/70

(52) U.S. Cl. CPC G06V 10/235; G06T 7/50; G06T 7/70; G06T 2207/10028

(57) ABSTRACT

The present disclosure provides a method for generating a bounding box and an apparatus for generating a bounding box, a device and a storage medium, which relate to the field of artificial intelligence, and in particular, to the technical fields of computer vision, cloud computing, intelligent search, Internet of Vehicles, and intelligent cockpits. The specific implementation solution is as follows: acquiring a depth map to be processed and depth information corresponding to the depth map; capturing a selection action by a user for a target object on the depth map; then, based on the selection action, determining, in the depth information, boundary point cloud information of the target object; and finally, based on the boundary point cloud information, generating a bounding box of the target object.

### CROSS-REFERENCE TO RELATED APPLICATIONS

This application claims priority to Chinese Patent Application No. 202210212672.3, filed on Mar. 4, 2022, which is hereby incorporated by reference in its entirety.

### TECHNICAL FIELD

The present disclosure relates to the technical fields of computer vision, cloud computing, intelligent search, Internet of Vehicles, and intelligent cockpits in the field of artificial intelligence, and in particular, to a method and an apparatus for generation a bounding box, a device and a storage medium.

### BACKGROUND

When creating a high-precision map or updating the high-precision map, it is necessary to make a bounding box of each object in the environment to provide support for creating a high-definition map.

In the related art, a method of generating the bounding box of the object is as follows: first, acquired environmental data or environmental point cloud data is displayed in a three-dimensional (3D) space; then, an operator identifies a target object in the 3D space and determines a target object boundary; next, an initial shape of the bounding box of the target object is determined by drawing points, lines, etc.; and finally, the bounding box of the target object is obtained by bounding box correction.

### SUMMARY

According to a first aspect of the present disclosure, there is provided a method for generating a bounding box, including:

acquiring a depth map to be processed and depth information corresponding to the depth map;

capturing a selection action by a user for a target object on the depth map; based on the selection action, determining, in the depth information, boundary point cloud information of the target object; and based on the boundary point cloud information, generating a bounding box of the target object.

According to a second aspect of the present disclosure, there is provided an apparatus for generating a bounding box, including:

at least one processor; and

a memory connected with the at least one processor in a communication way; where, the memory stores instructions executable by the at least one processor, and the instructions, when executed by the at least one processor, enables the at least one processor to perform the method according to the first aspect.

According to a third aspect of the present disclosure, there is provided a non-transitory computer-readable storage medium storing computer instructions, where the computer instructions are used to cause a computer to perform the method according to the first aspect.

### BRIEF DESCRIPTION OF THE DRAWINGS

The accompanying drawings are for better understanding of the solutions and do not constitute a limitation onto the present disclosure, in which:

FIG. 1 is a schematic diagram of an architecture to which an embodiment of the present disclosure is applicable;

FIG. 2 is a schematic flowchart of a method for generating a bounding box provided by Embodiment I of the present disclosure;

FIG. 3 is a schematic diagram of a relationship between a depth map and depth information;

FIG. 4 is a schematic flowchart of a method for generating a bounding box provided by Embodiment II of the present disclosure;

FIG. 5 is a schematic diagram of a process of determining boundary point cloud information of a target object based on a frame selection action;

FIG. 6 is a schematic flowchart of a method for generating a bounding box provided by Embodiment III of the present disclosure;

FIG. 7 is a schematic flowchart of a method for generating a bounding box provided by Embodiment IV of the present disclosure;

FIG. 8 is a schematic structural diagram of an apparatus for generating a bounding box provided by an embodiment of the present disclosure; and

FIG. 9 is a schematic block diagram of an example electronic device for implementing the embodiments of the present disclosure.

### DESCRIPTION OF EMBODIMENTS

The exemplary embodiments of the present disclosure are described below with reference to the accompanying drawings, including various details of the embodiments of the present disclosure for understanding the present disclosure, which should be considered as merely exemplary. Therefore, those of ordinary skill in the art should realize that various changes and modifications can be made to the embodiments described herein without departing from the scope and the spirit of the present disclosure. Likewise, for clarity and conciseness, descriptions of well-known functions and structures are omitted below.

Under the dual effects of smart economic tide and a new infrastructure, the rapid development of digital cities, autonomous driving and other fields has puts forward higher requirements for the map industry that serves as a “Base”-type business. Therefore, the creation or update of a high-precision map is a key factor, and the premise of the creation or update of the high-precision map is to make the bounding box of each object in the map.

Based on records in the background, it can be known that, the method for generating a bounding box in a three-dimensional scene has some problems, such as low production efficiency, high cost, and inability to achieve mass production, of which a main reason is: the need for 3D rendering based on point cloud editing, and point cloud data is the input reference material, which has a large amount of data, slow loading and rendering, and high requirements for machine performance. In addition, point cloud-based editing operations are complex, have high requirements for operators, and have problems of high cost, unfavorable quantitative production, poor visual effect, not intuitive enough, unclear edge of point cloud and time-consuming.

In view of the above technical problems, the technical conception process of embodiments of the present disclosure is as follows: the inventor discovers that when the target region is for data acquisition, a depth map of the target region and depth information of the depth map can be acquired synchronously, where the depth map is an image of a known acquisition position (e.g., shooting camera coordinates), the depth information of the depth map is sparse point cloud information corresponding to the image, and the sparse point cloud information mainly includes: pixel coordinates of the point cloud points in the image, three-dimensional relative coordinates of the point cloud points relative to the acquisition device (for example, a camera), three-dimensional absolute coordinates of the point cloud points, reflection intensity of the point cloud points, etc. Therefore, when human-computer interaction is carried out in the image, that is, when the target object is selected, boundary point cloud information in the depth information can be determined, thereby generating the bounding box of the target object.

Based on the above technical conception process, an embodiment of the present disclosure provide a method for generating a bounding box, which captures a selection action by a user for a target object on the depth map, then determines based on acquiring the depth map to be processed and the depth information corresponding to the depth map, based on the selection action, determines the boundary point cloud information of the target object in the depth information, and finally, generates the bounding box of the target object based on the boundary point cloud information. In this technical solution, the data in the depth information is edited based on the interactive operation in the depth map, and the boundary point cloud information of the target object can be automatically determined based on the user's selection action, thereby improving the generation efficiency of the bounding box, simplifying the processing complexity, and reducing the labor cost.

The present disclosure provides a method and an apparatus for generating a bounding box, a device and a storage medium, which are applied to the technical fields of computer vision, cloud computing, intelligent search, Internet of Vehicles, and intelligent cockpits in the field of artificial intelligence, so as to improve the generation efficiency of the bounding box of the object, reduce the cost, and lay the foundation for quantitative production.

It should be noted that the bounding box in this embodiment is not used for a specific object, and cannot reflect the information of a specific object. It should be noted that the depth map and the depth information in this embodiment are both from the public data set.

In the technical solution of the present disclosure, collection, storage, use, processing, transmission, provision and disclosure of the user's personal information involved are in compliance with relevant laws and regulations, and do not violate public order and good custom.

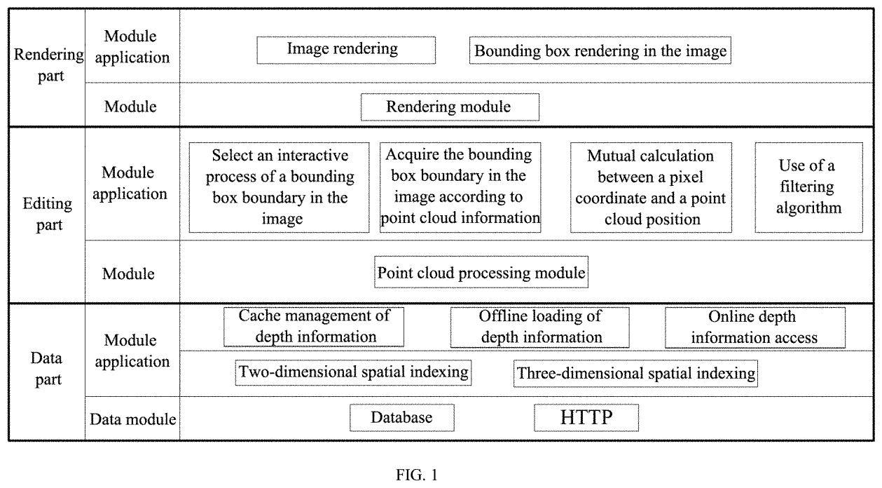

Exemplarily, FIG. 1 is a schematic diagram of an architecture to which an embodiment of the present disclosure is applicable. As shown in FIG. 1, the schematic diagram of the architecture includes: a data part, an editing part and a rendering part.

As shown in FIG. 1, the data part mainly includes a data module and an application of the data module.

A data acquisition method of the data module mainly includes: reading from the database or acquiring from the server through the hypertext transfer protocol (HTTP).

The module application mainly includes: data indexing and processing of depth information. The data indexing methods include: two-dimensional spatial indexing and three-dimensional spatial indexing. In the embodiment of the present disclosure, the two-dimensional spatial indexing mainly refers to the index of the depth map, and the three-dimensional spatial indexing mainly refers to the index of the depth information.

The processing of the depth information includes: cache management of the depth information (mainly referring to the cache of the depth information that has been processed or used), offline loading of the depth information (which can be understood as loading the depth information locally), online depth information access (including: acquiring the depth information from the server through networking), etc.

The editing part may include a point cloud processing module and an application of the point cloud processing module. Where the application of the point cloud processing module mainly includes: an interactive process of selecting the bounding box boundary in the image, acquiring the bounding box boundary in the image according to the point cloud information, and mutual calculation of a pixel coordinate and a point cloud position and use of a filtering algorithm, etc.

The rendering part may include a rendering module and an application of the rendering module. The application of the rendering module mainly includes: image rendering and bounding box rendering in the image.

It can be understood that the architecture scenario shown in FIG. 1 may also include other modules, for example, a storage module, which is not limited in the embodiment of the present disclosure.

It should be noted that the device executing the embodiment of the present disclosure may be a terminal device, a server or a virtual machine, or a distributed computer system composed of one or more servers and/or computers. Where the terminal device includes, but is not limited to: a smart phone, a notebook computer, a desktop computer, a platform computer, an on-board device, a smart wearable device, etc., which are not limited in the embodiment of the present disclosure. The server can be an ordinary server or a cloud server. The cloud server is also called a cloud computing server or a cloud host, and is a host product in a cloud computing service system. The server can also be a server of a distributed system, or a server combined with a blockchain.

It is worth noting that a product realization form of the present disclosure is a program code contained in the platform software and deployed on the device (it may also be hardware with computing capabilities such as a computing cloud or a mobile terminal). The program code of the present disclosure may be stored inside a device that executes an embodiment of the present disclosure. During running, the program code runs in the host memory and/or GPU memory of the device.

In the embodiments of the present disclosure, “plurality” refers to two or more. “and/or”, which describes an association relationship of associated objects, indicates that there can be three kinds of relationships, for example, “A and/or B” can mean: A exists alone, A and B exist at the same time, and B exists alone. The character “/” generally indicates that the associated objects are of an “or” relationship.

The method for generating a bounding box provided by an embodiment of the present disclosure will be described in detail below with specific embodiments in conjunction with the accompanying drawings. The following specific embodiments may be combined with each other, and the same or similar concepts or processes may not be repeated in some embodiments.

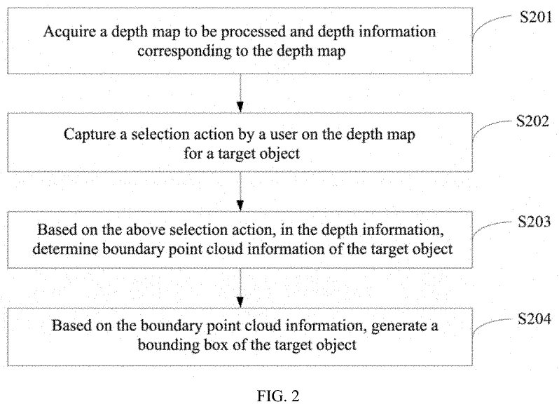

FIG. 2 is a schematic flowchart of a method for generating a bounding box provided by Embodiment I of the present disclosure. As shown in FIG. 2, the method for generating a bounding box may include following steps.

S201, acquire a depth map to be processed and depth information corresponding to the depth map.

In the embodiment of the present disclosure, the depth map to be processed and the depth information corresponding to the depth map can be received from other devices, read from its own database, or acquired from the server based on the HTTP.

In an implementation, after the depth information corresponding to the depth map is acquired, the depth information can be filtered to remove noise points in the depth information and improve the point cloud quality in the depth information.

It can be understood that in the embodiment of the present disclosure, the depth map to be processed and the depth information corresponding to the depth map may be preprocessed data or unprocessed data, which is not limited in this embodiment.

In an embodiment of the present disclosure, a depth map is an image of a known position, where the position refers to shooting camera coordinates of the depth map, and the depth information of the depth map is the sparse point cloud information corresponding to the image. The point cloud information mainly includes: the pixel coordinates of the point cloud points in the image, the three-dimensional relative coordinates of the point cloud points relative to the camera, the three-dimensional absolute coordinates of the point cloud points, the reflection intensity of the point cloud points, etc.

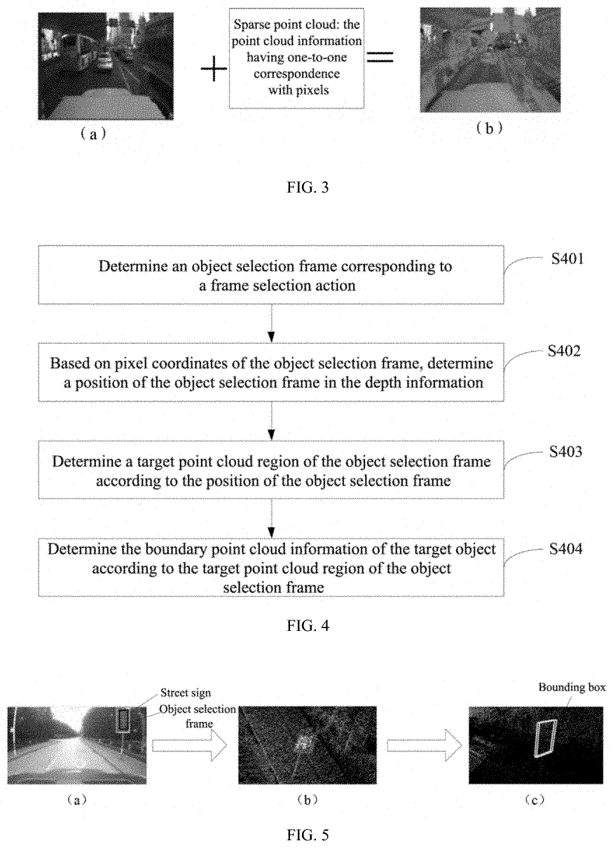

Exemplarily, FIG. 3 is a schematic diagram of a relationship between a depth map and depth information. The (a) of FIG. 3 is the depth map of a certain region. When a sparse point cloud (that is, the point cloud information having one-to-one correspondence with pixels) is added to the depth map, the depth information corresponding to the depth map can be acquired, as shown in (b) of FIG. 3.

S202, capture a selection action by a user on the depth map for a target object.

Exemplarily, after the depth map is acquired, the depth map can be displayed on the human-computer interaction interface, so that the user can operate on the depth map. In an implementation, the user can select the target object for which the bounding box is generated on the depth map, based on the object information displayed in the image. Thus, the device executing the embodiments of the present disclosure can capture the selection action by the user for the target object on the depth map.

Exemplarily, the selection action may be a frame selection action or a click selection action, which is not limited in this embodiment.

S203, based on the above selection action, in the depth information, determine boundary point cloud information of the target object.

In an implementation, when the device executing the embodiments of the present disclosure captures the selection action by the user on the depth map, the target point cloud information of the target object can be determined in the depth information, based on the corresponding relationship between the depth map and the depth information, so as to determine the boundary point cloud information of the target object.

It can be understood that, in the embodiment of the present disclosure, the target object may be one object, for example, a street sign; and it may also be a group of objects related to each other, for example, traffic lights, etc., which is not limited in this embodiment.

S204, based on the boundary point cloud information, generate a bounding box of the target object.

In an implementation, after determining the boundary point cloud information of the target object, the bounding box of the target object in a three-dimensional space can be generated, based on the three-dimensional absolute coordinates of the point cloud points in the boundary point cloud information.

It can be understood that, before this step, the determined boundary point cloud information can also be filtered to remove noise points, so as to generate a bounding box with a clear boundary, thereby improving the visual effect of the bounding box.

It is worth noting that in the embodiment of the present disclosure, the filtering processing method may include, but is not limited to, plane-based feature point filtering, statistical filtering, etc. Moreover, in practical applications, whether a filtering processing is required and the filtering processing method selected when the filtering processing is required may be determined according to the data quality of the depth information.

For example, the data quality of processed point cloud data is good, after the boundary point cloud information of the target object is determined, filtering processing is not required; while the data quality of unprocessed point cloud data is poor, and filtering processing is required.

In the embodiment of the present disclosure, the depth map to be processed and the depth information corresponding to the depth map is acquired, a selection action by a user for a target object on the depth map is captured; and then the boundary point cloud information of the target object in the depth information is determined based on the selection action; and finally, the bounding box of the target object is generated based on the boundary point cloud information. In this technical solution, the data in the depth information is edited based on the interactive operation in the depth map, and the boundary point cloud information of the target object can be automatically determined based on the user's selection action, thereby improving the generation efficiency of the bounding box, simplifying the processing complexity, and reducing the labor cost.

Based on the embodiment shown in FIG. 2, the method for generating a bounding box provided by an embodiment of the present disclosure will be described in more detail below.

Exemplarily, FIG. 4 is a schematic flowchart of a method for generating a bounding box provided by Embodiment II of the present disclosure. As shown in FIG. 4, in the embodiment of the present disclosure, the above selection action is a frame selection action, and accordingly, the above S203 may be implemented by the following steps.

S401, determine an object selection frame corresponding to a frame selection action.

As an example, when the selection action by the user on the depth map is a frame selection, at this time, the object selection frame formed by the frame selection action can be determined based on the position of the frame selection action in the depth map.

S402, based on pixel coordinates of the object selection frame, determine a position of the object selection frame in the depth information.

In an implementation, since the depth map is an image with pixel coordinates, after the object selection frame corresponding to the frame selection action is determined, the pixel coordinates of the object selection frame can be determined, and then the position of the object selection frame in the depth information can be determined, based on the correspondence between the pixel coordinates and the point cloud points in the depth information.

S403, determine a target point cloud region of the object selection frame according to the position of the object selection frame.

In the embodiment of the present disclosure, after the position of the object selection frame is determined in the sparse point cloud information corresponding to the depth information, the target point cloud region within the frame selection range can be determined based on the frame selection range of the position, that is, the target point cloud region of this object selection frame.

S404, determine the boundary point cloud information of the target object according to the target point cloud region of the object selection frame.

In this embodiment, since the bounding box of the target object is to be generated, after the target point cloud region of the object selection frame is determined, the boundary information of the target point cloud region is determined, thus the boundary point cloud information of the target object is determined.

In this embodiment, the bounding box of the target object is determined by the accuracy of the user's frame selection. The more accurate the position of the user's frame selection for the target object in the depth map is, the more accurate the boundary point cloud information of the target object determined in the depth information will be. This may also be explained that the size of the object selection frame selected by the user determines the size of the bounding box generated in the depth information.

Exemplarily, FIG. 5 is a schematic diagram of a process of determining boundary point cloud information of a target object based on a frame selection action. As shown in (a) of FIG. 5, if the user selects a street sign on the road in the depth map through a frame, the object selection frame corresponding to the frame selection action is a black thick solid line in the street sign. At this point, referring to (b) of FIG. 5, based on the position of the object selection frame, the target point cloud region within the frame selection range corresponding to the object selection frame can be selected from the depth information of the depth map; and finally, referring to (c) of FIG. 5, the boundary point cloud information of the target object can be determined based on the boundary information of the target point cloud region.

It can be understood that the point cloud information shown in (b) and (c) of FIG. 5 is a part of the depth information corresponding to the depth map shown in (a) of FIG. 5, which is only illustrated as an example and is not limited in this embodiment.

In the embodiment of the present disclosure, by determining the object selection frame corresponding to the frame selection action, and based on the pixel coordinates of the object selection frame, the position of the object selection frame in the depth information is determined, the target point cloud information of the object selection frame is then determined according to the position of the object selection frame, and the target point cloud information of the object selection frame is determined as the boundary point cloud information of the target object. In this technical solution, the object selection frame is formed based on the frame selection action by the user, and then the boundary point cloud information of the target object is determined. Such implementation method is simple, and the generation efficiency of the bounding box is high.

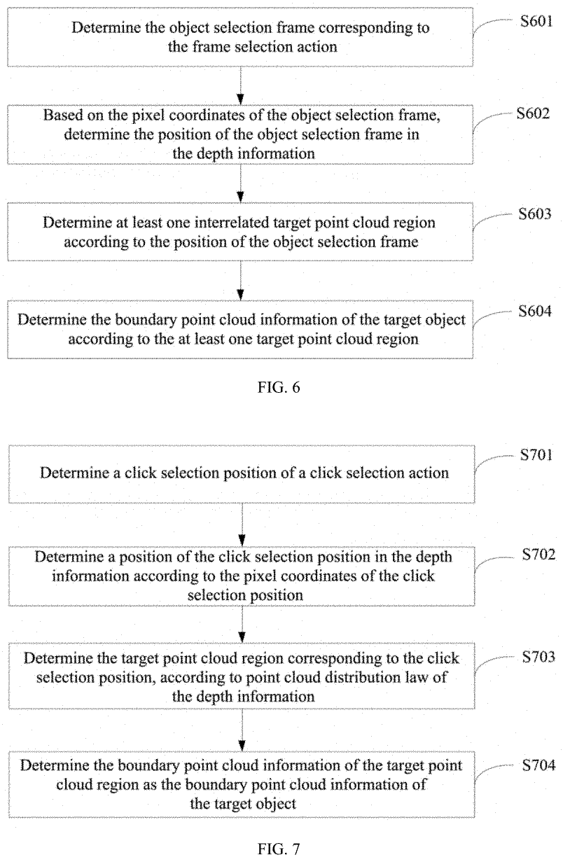

It can be understood that the embodiment shown in FIG. 6 is another implementation solution for determining the boundary point cloud information of the target object based on the frame selection action.

Exemplarily, FIG. 6 is a schematic flowchart of a method for generating a bounding box provided by Embodiment III of the present disclosure. As shown in FIG. 6, in the embodiment of the present disclosure, the above selection action is a frame selection action, and accordingly, the above S203 may be implemented by following steps.

S601, determine the object selection frame corresponding to the frame selection action.

S602, based on the pixel coordinates of the object selection frame, determine the position of the object selection frame in the depth information.

In an implementation, for the specific implementation of S601 and S602 in this embodiment, reference may be made to S401 and S402 in the embodiment shown in FIG. 4, which will not be repeated herein.

S603, determine at least one interrelated target point cloud region according to the position of the object selection frame.

In an embodiment of the present disclosure, when the position of the object selection frame is determined in the sparse point cloud information corresponding to the depth information, at least one target point cloud region of the object corresponding to the object selection frame can be determined based on the number of point cloud points at the position of the object selection frame, the density of point cloud points and the point cloud distribution law, where the at least one target point cloud region is correlated. That is, the at least one target point cloud region is a point cloud region of objects having the same properties.

Exemplarily, in this embodiment, if the target object corresponding to the frame selection action is a street sign, the target point cloud region is the point cloud region of the street sign; that is, regardless of the size of the object selection frame selected by the user through a frame, the target point cloud region is the point cloud region of the street sign, which is not limited to the size of the object selection frame.

Exemplarily, if the user selects one of the traffic lights in the depth map through a frame, since the traffic lights as a whole, the corresponding point cloud quantity and the point cloud density thereof are basically similar. Therefore, in the solution of this embodiment, the point cloud regions of all the traffic lights can be determined; that is, there are multiple target point cloud regions in this embodiment.

S604, determine the boundary point cloud information of the target object according to the at least one target point cloud region.

In this embodiment, when at least one associated target point cloud region is determined, based on the range of each target point cloud region, the boundary information of each target point cloud region can be determined and used as the boundary point cloud information of the target object.

In the embodiment of the present disclosure, by determining the object selection frame corresponding to the frame selection action, and based on the pixel coordinates of the object selection frame, the position of the object selection frame in the depth information is determined; then, according to the position of the object selection frame, at least one interrelated target point cloud region is determined; and finally, the boundary point cloud information of the target object is determined according to the at least one target point cloud region. In this technical solution, there may actually be at least one target object; that is, the boundary point cloud information of a group of objects can be determined through the frame selection action, which improves the generation efficiency of bounding boxes, lays a foundation for the subsequent generation of a group of bounding boxes, and provides the possibility of quantitative production of bounding boxes.

Exemplarily, FIG. 7 is a schematic flowchart of a method for generating a bounding box provided by Embodiment IV of the present disclosure. As shown in FIG. 7, in the embodiment of the present disclosure, the above selection action is a click selection action, and accordingly, the above S203 can be implemented by following steps.

S701, determine a click selection position of a click selection action.

As an example, when the selection action of the user on the depth map is a click selection action, at this point, the click selection position of the click selection action in the depth map can be acquired.

S702, determine a position of the click selection position in the depth information according to the pixel coordinates of the click selection position.

In an implementation, since the depth map is an image with pixel coordinates, after the click selection position of the click selection action is determined, the pixel coordinates of the click selection position can be determined, and then, based on the correspondence between the pixel coordinates and the point cloud points in the depth information, the position of the click selection position in the depth information can be determined.

S703, determine the target point cloud region corresponding to the click selection position click position, according to point cloud distribution law of the depth information.

Exemplarily, in the embodiment of the present disclosure, in case of determining the position of the click selection position in the depth information, the target point cloud region corresponding to the click selection position can be determined based on the number of point cloud points within the preset range of the click selection position, the density of the point cloud points, and the of the point cloud distribution law.

For example, when the user clicks and selects a street sign in the depth map containing the street sign, in this solution, the target point cloud region corresponding to the street sign in the depth information can be determined.

S704, determine the boundary point cloud information of the target point cloud region as the boundary point cloud information of the target object.

In this embodiment, in case of determining the target point cloud region corresponding to the click selection position, based on the range of the target point cloud region, the boundary information of the target point cloud region can be determined and used as the boundary point cloud information of the target object.

In an embodiment of the present disclosure, by determining the click selection position, and according to the pixel coordinates of the click selection position, the position of the click selection position in the depth information is determined; then, according to the point cloud distribution law of the depth information, the target point cloud region corresponding to the click selection position is determined; and finally, the boundary point cloud information of the target point cloud region is determined as the boundary point cloud information of the target object. In this technical solution, the boundary point cloud information of the target object can be automatically determined by the click selection action, which improves the generation efficiency of the bounding box, simplifies the processing complexity, and reducing the labor cost.

In an embodiment of the present disclosure, the method for generating a bounding box may further include a display part of the bounding box.

In a possible implementation of the present disclosure, the method for generating a bounding box may further include:

displaying the bounding box of the target object in the three-dimensional space.

Exemplarily, in this possible implementation, the bounding box is generated in the three-dimensional space, and thus, the bounding box of the target object can be directly displayed in the three-dimensional space, for example, as shown in (c) of FIG. 5.

In another possible implementation of the present disclosure, the method for generating a bounding box may further include:

determining the position of the bounding box in the depth map according to the correspondence between the pixel coordinates and the point cloud information; and

based on the position of the bounding box in the depth map, displaying the bounding box of the target object in the depth map.

In this possible implementation, the bounding box of the target object can also be displayed in the depth map; since the bounding box is generated based on point cloud information in the three-dimensional space, reverse processing is required for the generated bounding box.

Specifically, according to the boundary point cloud information of the target object, the position of the bounding box in the depth map is determined, and then the position is highlighted in the depth map, so that the purpose of displaying the bounding box of the target object in the depth map is achieved.

In an embodiment of the present disclosure, the bounding box can be displayed in either a three-dimensional space or a depth map, which improves the diversity of the display and the visual effect of the user.

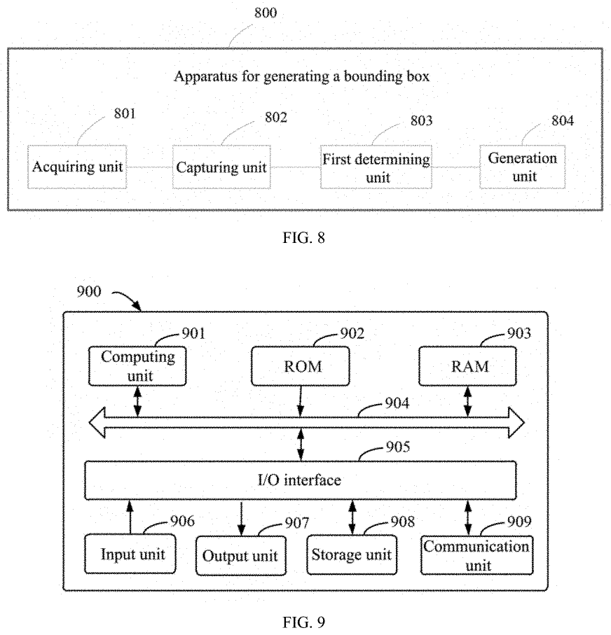

FIG. 8 is a schematic structural diagram of an apparatus for generating a bounding box provided by an embodiment of the present disclosure. The apparatus for generating a bounding box provided in this embodiment may be an electronic device or an apparatus in the electronic device. As shown in FIG. 8, an apparatus for generating a bounding box 800 provided by an embodiment of the present disclosure may include:

an acquiring unit 801, configured to acquire a depth map to be processed and depth information corresponding to the depth map;

a capturing unit 802, configured to capture a selection action by a user for a target object on the depth map;

a first determining unit 803, configured to determine, based on the selection action, in the depth information, boundary point cloud information of the target object ; and

a generation unit 804, configured to generate, based on the boundary point cloud information, a bounding box of the target object.

In a possible implementation of the embodiment of the present disclosure, the selection action is a frame selection action;

the first determining unit 803 includes:

a first selection frame determining module, configured to determine an object selection frame corresponding to the frame selection action;

a first position determining module, configured to determine a position of the object selection frame in the depth information based on pixel coordinates of the object selection frame;

a first region determining module, configured to determine a target point cloud region of the object selection frame according to the position of the object selection frame; and

a first boundary determining module, configured to determine the boundary point cloud information of the target object, according to the target point cloud region of the object selection frame.

In a possible implementation of the embodiment of the present disclosure, the selection action is a frame selection action;

the first determining unit 803 includes:

a second selection frame determining module, configured to determine an object selection frame corresponding to the frame selection action;

a second position determining module, configured to determine a position of the object selection frame in the depth information based on pixel coordinates of the object selection frame;

a second region determining module, configured to determine at least one interrelated target point cloud region, according to the position of the object selection frame; and

a second boundary determining module, configured to determine the boundary point cloud information of the target object, according to the at least one target point cloud region.

In a possible implementation of the embodiment of the present disclosure, the selection action is a click selection action;

the first determining unit 803 includes:

a click selection position determining module, configured to determine a click selection position of the click selection action;

a third position determining module, configured to determine a position of the click selection position in the depth information, according to pixel coordinates of the click selection position;

a third region determining module, configured to determine a target point cloud region corresponding to the click selection position, according to a point cloud distribution law of the depth information; and

a third boundary determining module, configured to determine boundary point cloud information of the target point cloud region as the boundary point cloud information of the target object.

In a possible implementation of the embodiment of the present disclosure, the apparatus for generating a bounding box further includes:

a first display unit (not shown), configured to display the bounding box of the target object in a three-dimensional space.

In a possible implementation of the embodiment of the present disclosure, the apparatus for generating a bounding box further includes:

a second determining unit (not shown), configured to determine the position of the bounding box in the depth map according to a correspondence between pixel coordinates and point cloud information; and

a second display unit (not shown), configured to display the bounding box of the target object in the depth map based on the position of the bounding box in the depth map.

In a possible implementation of the embodiment of the present disclosure, the apparatus for generating a bounding box further includes:

a first filtering unit (not shown), configured to filter the boundary point cloud information.

In a possible implementation of the embodiment of the present disclosure, the apparatus for generating a bounding box further includes:

a second filtering unit (not shown), configured to filter the depth information.

The apparatus for generating a bounding box provided in this embodiment can be used to perform the method for generating a bounding box according to any one of the above method embodiments, and their implementation principles and technical effects are similar, which will not be repeated herein.

According to an embodiment of the present disclosure, the present disclosure further provides an electronic device, a readable storage medium, and a computer program product.

According to an embodiment of the present disclosure, the present disclosure further provides a computer program product, including: a computer program which is stored in a readable storage medium, at least one processor of an electronic device may read the computer program from the readable storage medium, and the at least one processor executes the computer program to cause the electronic device to perform the solution provided by any one of the above embodiments.

FIG. 9 is a schematic block diagram of an example electronic device for implementing the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile apparatuses, such as a personal digital assistant, a cellular phone, a smart phone, a wearable device, and other similar computing apparatuses. The components, their connections and relationships, and their functions shown herein are by way of example only, and are not intended to limit implementations of the present disclosure described and/or claimed herein.

As shown in FIG. 9, a device 900 includes a computing unit 901, which can perform, according to a computer program stored in a read-only memory (ROM) 902 or a computer program loaded from a storage unit 908 to a random access memory (RAM) 903, various appropriate actions and processes. In the RAM 903, various programs and data required for the operation of the device 900 can also be stored. The computing unit 901, the ROM 902, and the RAM 903 are connected to each other through a bus 904. An input/output (I/O) interface 905 is also connected to the bus 904.

Multiple components in the device 900 are connected to the I/O interface 905, including: an input unit 906, such as a keyboard, a mouse, etc.; an output unit 907, such as various types of displays, speakers, etc.; the storage unit 908, such as a magnetic disk, an optical disc, etc.; and a communication unit 909, such as a network card, a modem, a wireless communication transceiver, etc. The communication unit 909 allows the device 900 to exchange information/data with other devices through a computer network such as an Internet and/or various telecommunication networks.

The computing unit 901 may be various general-purpose and/or special-purpose processing components with processing and computing capabilities. Some examples of the computing unit 901 include, but are not limited to, a central processing unit (CPU), a graphics processing unit (GPU), various dedicated artificial intelligence (AI) computing chips, various computing units that run machine learning model algorithms, a digital signal processor (DSP), any appropriate processor, controller, microcontroller, etc. The computing unit 901 performs the various methods and processing described above, for example, the method for generating a bounding box. For example, in some embodiments, the method for generating a bounding box may be implemented as a computer software program, which is tangibly contained in a machine-readable medium, such as the storage unit 908. In some embodiments, part or entire of the computer program may be loaded and/or installed on the device 900 via the ROM 902 and/or the communication unit 909. When the computer program is loaded into the RAM 903 and executed by the computing unit 901, one or more steps of the method for generating a bounding box described above can be performed. Alternatively, in other embodiments, the computing unit 901 may be configured to perform, in any other suitable manner (for example, by means of firmware), the method for generating a bounding box.

Various implementations of the systems and technologies described above herein can be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), computer hardware, firmware, software, and/or combinations thereof. These various implementations may include: being implemented in one or more computer programs, where the one or more computer programs may be executed and/or interpreted on a programmable system including at least one programmable processor, and the programmable processor may be a dedicated or general programmable processor, may receive data and instructions from a storage system, at least one input apparatus, and at least one output apparatus, and transmit the data and the instructions to the storage system, the at least one input apparatus and the at least one output apparatus.

The program code used to implement the method of the present disclosure can be written in any combination of one or more programming languages. These program codes can be provided to a processor or a controller of a general-purpose computer, a special-purpose computer, or other programmable data processing apparatuses, so that when the program codes are executed by the processor or the controller, functions/operations specified in the flowchart and/or the block diagram are implemented. The program code can be executed entirely on a machine and partly on the machine, and the program code, as an independent software package, can be executed partly on the machine and partly on a remote machine, or can be executed completely on the remote machine or the server.

In the context of the present disclosure, a machine-readable medium may be a tangible medium that may contain or store a program for use by or in combination with an instruction execution system, an apparatus, or a device. The machine-readable medium can be a machine-readable signal medium or a machine-readable storage medium. The machine-readable medium may include, but is not limited to, an electronic, a magnetic, an optical, an electromagnetic, an infrared, or a semiconductor system, apparatus, or device, or any suitable combination of the above. More specific examples of machine-readable storage medium would include an electrical connection based on one or more wires, a portable computer disk, a hard disk, a random access memory (RAM), a read-only memory (ROM), an erasable programmable read-only memory (EPROM or flash memory), optical fiber, a portable compact disk read-only memory (CD-ROM), an optical storage device, a magnetic storage device, or any appreciate combination of the above.

In order to provide interaction with the user, the systems and technologies described herein can be implemented on a computer, and the computer has: a display apparatus (for example, a CRT (cathode ray tube) or a LCD (liquid crystal display) monitor) for displaying information to the user; as well as a keyboard and a pointing apparatus (for example, a mouse or a trackball), and the user can provide input to the computer through the keyboard and the pointing apparatus. Other types of apparatuses can also be used to provide interaction with the user; for example, feedback provided to the user can be any form of sensory feedback (for example, visual feedback, auditory feedback or tactile feedback); and any form (including sound input, voice input or tactile input) can be used to receive input from the user.

The systems and technologies described here can be implemented in a computing system that includes back-end components (for example, as a data server), or in a computing system that includes middleware components (for example, an application server), or in a computing system that includes front-end components (for example, a user computer with a graphical user interface or web browser, through which the user can interact with the implementations of the systems and technologies described here), or in a computing system that includes any combination of such back-end components, middleware components, or front-end components. The components of the system can be connected to each other through any form or medium of digital data communication (for example, a communication network). Examples of the communication network include: a local area network (LAN), a wide area network (WAN) and an Internet.

The computer system can include a client and a server. The client and the server are generally far away from each other and usually interact through a communication network. A relationship between the client and the server is generated through running a computer program on the corresponding computer and having a client-server relationship with each other. The server can be a cloud server, which is also called a cloud computing server or a cloud host, and the server is a host product in the cloud computing service system for solving defects of difficult management and weak business expansion in service of a traditional physical host and a VPS (Virtual Private Server). The server can also be a server of a distributed system, or a server combined with a block chain.

Understanding that the various forms of processes shown above can be used to reorder, add or delete steps. For example, the steps recorded in the present disclosure can be performed in parallel, sequentially, or in a different order, as long as a desired result of the technical solution disclosed in the present disclosure can be achieved, which is not limited herein.

The above specific implementations do not constitute a limitation onto the scope of protection of the present disclosure. Those skilled in the art should understand that various modifications, combinations, sub-combinations, and substitutions can be made according to design requirements and other factors. Any amendments, equivalent substitutions and improvements made within the spirit and principles of the present disclosure shall be included in the scope of protection of the present disclosure.

What is claimed is:

1. A method for generating a bounding box for generating a bounding box, comprising:
acquiring a depth map to be processed and depth information corresponding to the depth map;
capturing a selection action by a user for a target object on the depth map;
based on the selection action, determining, in the depth information, boundary point cloud information of the target object; and
based on the boundary point cloud information, generating a bounding box of the target object.

2. The method according to claim 1, wherein the selection action is a frame selection action;
the based on the selection action, determining, in the depth information, boundary point cloud information of the target object comprises:
determining an object selection frame corresponding to the frame selection action;
determining a position of the object selection frame in the depth information based on pixel coordinates of the object selection frame;
determining a target point cloud region of the object selection frame, according to the position of the object selection frame; and
determining the boundary point cloud information of the target object, according to the target point cloud region of the object selection frame.

3. The method according to claim 1, wherein the selection action is a frame selection action;
the based on the selection action, determining, in the depth information, boundary point cloud information of the target object comprises:
determining an object selection frame corresponding to the frame selection action;
determining a position of the object selection frame in the depth information based on pixel coordinates of the object selection frame;
determining at least one interrelated target point cloud region, according to the position of the object selection frame; and
determining the boundary point cloud information of the target object, according to the at least one target point cloud region.

4. The method according to claim 1, wherein the selection action is a click selection action;
the based on the selection action, determining, in the depth information, boundary point cloud information of the target object comprises:
determining a click selection position of the click selection action;
determining a position of the click selection position in the depth information, according to pixel coordinates of the click selection position;
determining a target point cloud region corresponding to the click selection position, according to a point cloud distribution law of the depth information; and
determining boundary point cloud information of the target point cloud region as the boundary point cloud information of the target object.

5. The method according to claim 1, further comprising:
displaying the bounding box of the target object in a three-dimensional space.

6. The method according to claim 2, further comprising:
displaying the bounding box of the target object in a three-dimensional space.

7. The method according to claim 3, further comprising:
displaying the bounding box of the target object in a three-dimensional space.

8. The method according to claim 4, further comprising:
displaying the bounding box of the target object in a three-dimensional space.

9. The method according to claim 1, further comprising:
determining the position of the bounding box in the depth map, according to a correspondence between pixel coordinates and the point cloud information; and
based on the position of the bounding box in the depth map, displaying the bounding box of the target object in the depth map.

10. The method according to claim 2, further comprising:
determining the position of the bounding box in the depth map, according to a correspondence between pixel coordinates and the point cloud information; and
based on the position of the bounding box in the depth map, displaying the bounding box of the target object in the depth map.

11. The method according to claim 3, further comprising:
determining the position of the bounding box in the depth map, according to a correspondence between pixel coordinates and the point cloud information; and
based on the position of the bounding box in the depth map, displaying the bounding box of the target object in the depth map.

12. The method according to claim 4, further comprising:
determining the position of the bounding box in the depth map, according to a correspondence between pixel coordinates and the point cloud information; and
based on the position of the bounding box in the depth map, displaying the bounding box of the target object in the depth map.

13. The method according to claim 1, before generating the bounding box of the target object based on the boundary point cloud information, further comprising:
filtering the boundary point cloud information.

14. The method according to claim 1, before capturing the selection action by the user for the target object the depth map, further comprising:
filtering the depth information.

15. An apparatus for generating a bounding box, comprising:
at least one processor; and
a memory connected with the at least one processor in a communication way; wherein,
the memory stores instructions executable by the at least one processor, and the instructions, when executed by the at least one processor, enables the at least one processor to:
acquire a depth map to be processed and depth information corresponding to the depth map;
capture a selection action by a user for a target object on the depth map;
determine, based on the selection action, in the depth information, boundary point cloud information of the target object; and
generate, based on the boundary point cloud information, a bounding box of the target object.

16. The apparatus according to claim 15, wherein the selection action is a frame selection action;
the at least one processor is further enabled to:
determine an object selection frame corresponding to the frame selection action;
determine a position of the object selection frame in the depth information based on pixel coordinates of the object selection frame;
determine a target point cloud region of the object selection frame, according to the position of the object selection frame; and
determine the boundary point cloud information of the target object, according to the target point cloud region of the object selection frame.

17. The apparatus according to claim 15, wherein the selection action is a frame selection action;
the at least one processor is further enabled to: determine an object selection frame corresponding to the frame selection action;
determine a position of the object selection frame in the depth information based on pixel coordinates of the object selection frame;
determine at least one interrelated target point cloud region, according to the position of the object selection frame; and
determine the boundary point cloud information of the target object, according to the at least one target point cloud region.

18. The apparatus according to claim 15, wherein the selection action is a click selection action;
the at least one processor is further enabled to:
determine a click selection position of the click selection action;
determine a position of the click selection position in the depth information, according to pixel coordinates of the click selection position;
determine a target point cloud region corresponding to the click selection position, according to a point cloud distribution law of the depth information; and
determine boundary point cloud information of the target point cloud region as the boundary point cloud information of the target object.

19. The apparatus according to claim 15, wherein the at least one processor is further enabled to:
display the bounding box of the target object in a three-dimensional space.

20. A non-transitory computer-readable storage medium storing computer instructions, wherein the computer instructions are used to cause a computer to perform the following steps:
acquiring a depth map to be processed and depth information corresponding to the depth map;
capturing a selection action by a user for a target object on the depth map;
based on the selection action, determining, in the depth information, boundary point cloud information of the target object; and
based on the boundary point cloud information, generating a bounding box of the target object.
